(19) United States
(12) Patent Application Publication
(10) Pub. No.: US 2016/0323881 A1
(43) Pub. Date: Nov. 3, 2016

(54) TECHNIQUES FOR USING ALTERNATE CHANNELS FOR ACKNOWLEDGEMENT MESSAGES

(71) Applicant: QUALCOMM Incorporated, San Diego, CA (US)

(72) Inventors: Veerendra Bhora, Fremont, CA (US); Simone Merlin, San Diego, CA (US); Vincent Knowles Jones, IV, Redwood City, CA (US); Hemanth Sampath, San Diego, CA (US); Assaf Touboul, Netanya (IL); Adam Lapede, Los Altos, CA (US)

(21) Appl. No.: 15/141,763

(22) Filed: Apr. 28, 2016

Related U.S. Application Data
(60) Provisional application No. 62/156,153, filed on May 1, 2015.

(51) Int. Cl. H04W 72/04; H04L 5/00

(52) U.S. Cl. CPC H04W 72/0446; H04L 5/0055; H04W 84/12

(57) ABSTRACT

Methods, systems, and devices are described for wireless communication. An example wireless communication device may receive at least a portion of a data frame from another wireless communication device via a first or primary channel. The example wireless communication device may transmit a first acknowledgement message via a second or alternate channel, different from the first or primary channel, in response to the received data frame. In another example, an example wireless communication device may transmit a data frame via a first or primary channel. The wireless communication device may receive an acknowledgement message via a second or alternate channel, different from the first or primary channel in response to the data frame from another wireless communication device.

### CROSS REFERENCES

The present application for patent claims priority to U.S. Provisional Patent Application No. 62/156,153 by Bhora et al., entitled “Techniques for Using Alternate Channels for Acknowledgement Messages,” filed May 1, 2016, assigned to the assignee hereof and expressly incorporated by reference herein.

### BACKGROUND

1. Field of the Disclosure

The following relates generally to wireless communication, and more specifically to using alternate channels for acknowledgement messages.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a wireless fidelity (Wi-Fi) (i.e., IEEE 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). From the STA's perspective, the DL (or forward link) may refer to the communication link from the AP to the station, and the UL (or reverse link) may refer to the communication link from the station to the AP.

Acknowledgment (ACK) messages and block acknowledgement (BA) messages may be sent as an immediate response to a data Physical Layer Convergence Protocol (PLCP) Protocol Data Unit (PPDU) or a block acknowledgement request (BAR). The ACK and/or BA may be sent on the same channel having the same frequency sub-band and bandwidth on which the soliciting PPDU or BAR was received, which may cause interference for other transmissions and may require additional power to transmit these messages.

### SUMMARY

The present disclosure relates to systems, methods, and apparatus for using alternate channels for acknowledgement messages. Specifically, a wireless communication device (e.g., data receiving STA) may receive at least a portion of a data frame from another wireless communication device (e.g., AP or data transmitting STA) via a first or primary channel. The wireless communication device may transmit a first acknowledgement message (e.g., an ACK) via a second or alternate channel, different from the first or primary channel, in response to the received data frame. The wireless communication device may perform a channel contention procedure on the second or alternate channel after the data frame has been received. In this regard, the wireless communication device may transmit the first acknowledgement message via the second or alternate channel when the second or alternate channel is determined to be available based on the channel contention procedure. In some examples, the wireless communication device may transmit a second acknowledgement message via the first or primary channel in response to the received data frame. In accordance with aspects of the present disclosure, a wireless communication device (e.g., AP or data transmitting STA) may transmit a data frame via a first or primary channel. The wireless communication device may receive an acknowledgement message via a second or alternate channel, different from the first or primary channel in response to the data frame from another wireless communication device (e.g., data receiving STA). The wireless communication device may determine the first channel and the second channel are available for transmission, and may transmit the data frame via the second or alternate channel when the first channel and the second channel are determined to be available.

A method of wireless communication is described. The method may include receiving at least a portion of a data frame from a first wireless communication device via a first channel, and transmitting, by a second wireless communication device, a first acknowledgement message via a second channel, different from the first channel, in response to the received data frame.

An apparatus for wireless communication is described. The apparatus may include a data manager for receiving at least a portion of a data frame from a first wireless communication device via a first channel, and an alternate channel manager for transmitting, by a second wireless communication device, a first acknowledgement message via a second channel, different from the first channel, in response to the received data frame.

In some examples of the method or apparatus described herein, transmitting the first acknowledgement message via the second channel comprises transmitting the first acknowledgement message in response to the received data frame irrespective of a state of the second channel. Additionally or alternatively, in some examples the state of the second channel comprises a clear-channel assessment (CCA) state and/or a net allocation vector (NAV) state.

Some examples of the method or apparatus described herein may further include processes or features for transmitting the first acknowledgement message within a short interframe space (SIFS) time after the data frame has been received. Additionally or alternatively, some examples may include processes or features for performing, by the second wireless communication device, a channel contention procedure on the second channel after the data frame has been received, and transmitting the first acknowledgement message via the second channel comprises transmitting the first acknowledgement message when the second channel is determined to be available based at least in part on the channel contention procedure.

In some examples of the method or apparatus described herein, performing the channel contention procedure on the second channel comprises performing a clear-channel assessment (CCA) of the second channel, and winning the second channel based at least in part on the performed CCA. Additionally or alternatively, in some examples performing the channel contention procedure on the second channel comprises determining a net allocation vector (NAV) state associated with the second channel is clear.

In some examples of the method or apparatus described herein, performing the channel contention procedure on the second channel comprises performing the channel contention procedure utilizing enhanced distributed channel access (EDCA) techniques. Additionally or alternatively, some examples may include processes or features for transmitting, by the second wireless communication device, a second acknowledgement message via the first channel in response to the received data frame.

In some examples of the method or apparatus described herein, transmitting the second acknowledgement message comprises transmitting the second acknowledgement message via the first channel at a lower power level than a power level used to transmit the first acknowledgement message via the second channel. Additionally or alternatively, some examples may include processes or features for decoding, by the second wireless communication device, a portion of the received data frame prior to an entirety of the data frame being received, and transmitting the first acknowledgement message via the second channel comprises transmitting a partial acknowledgement message associated with the decoded portion of the data frame.

Some examples of the method or apparatus described herein may further include processes or features for transmitting, by the second wireless communication device, a subsequent acknowledgement message via the second channel when the entirety of the data frame has been received. Additionally or alternatively, in some examples the first channel operates in a wireless local area network (WLAN) frequency sub-band and the second channel operates in a non-wireless local area network (WLAN) frequency sub-band.

In some examples of the method or apparatus described herein, transmitting the first acknowledgement message via the second channel comprises transmitting acknowledgement (ACK) message, or a block acknowledgment (BA) message, or a negative acknowledgment (NACK) message, or a combination thereof.

A method of wireless communication is described. The method may include transmitting, by a first wireless communication device, a data frame via a first channel, and receiving an acknowledgement message via a second channel, different from the first channel in response to the data frame from a second wireless communication device.

An apparatus for wireless communication is described. The apparatus may include a data transmission manager for transmitting, by a first wireless communication device, a data frame via a first channel, and an alternate channel manager for receiving an acknowledgement message via a second channel, different from the first channel in response to the data frame from a second wireless communication device.

Some examples of the method or apparatus described herein may further include processes and features for determining the first channel and the second channel are available for transmission, and transmitting the data frame via the second channel comprises transmitting the data frame when the first channel and the second channel are determined to be available. Additionally or alternatively, in some examples determining the first channel and the second channel are available for transmission comprises performing, by the first wireless communication device, a channel contention procedure on each of the first channel and the second channel.

Some examples of the method or apparatus described herein may further include processes and features for transmitting, by the first wireless communication device, a request to send (RTS) message via the second channel. Additionally or alternatively, in some examples transmitting the data frame via the first channel comprises transmitting the data frame concurrently with the transmission of the RTS message or after the transmission of the RTS message.

Some examples of the method or apparatus described herein may further include processes and features for transmitting, by the first wireless communication device, a block acknowledgement request (BAR) message via the second channel to solicit the acknowledgement message, the BAR message being transmitted after the RTS message. Additionally or alternatively, in some examples transmitting the BAR message via the second channel comprises transmitting the BAR message when a transmitted portion of the data frame satisfies a transmission threshold.

In some examples of the method or apparatus described herein, transmitting the BAR message via the second channel comprises transmitting the BAR message after transmission of the data frame has been completed. Additionally or alternatively, some examples may include processes or features for transmitting, by the first wireless communication device, a block acknowledgement request (BAR) message via the second channel to solicit the acknowledgement message, and transmitting, by the first wireless communication device, a request for a continuous response from the second wireless communication device via the second channel.

Some examples of the method or apparatus described herein may further include processes or features for receiving the acknowledgement message in an aggregate medium access control (MAC) protocol data unit (AMPDU) in response to the request for the continuous response. Additionally or alternatively, some examples may include processes or features for performing, by the first wireless communication device, a channel contention procedure on the second channel after transmission of the data frame has been completed.

Some examples of the method or apparatus described herein may further include processes or features for transmitting, by the first wireless communication device, a first block acknowledgement request (BAR) message via the second channel to solicit the acknowledgement message, the first BAR message being transmitted during the transmission of the data frame. Additionally or alternatively, some examples may include processes or features for transmitting, by the first wireless communication device, a second BAR message via the second channel to solicit an additional acknowledgement message, the second BAR message being transmitted after the transmission of the data frame has been completed.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

Aspects of the disclosure are described in reference to the following figures:

FIG. 1 illustrates a wireless local area network (WLAN) for utilizing alternate channels for acknowledgement messages in accordance with various aspects of the present disclosure;

FIGS. 2A and 2B illustrate examples of communications between an AP and a STA that utilize alternate channels for acknowledgement messages in accordance with various aspects of the present disclosure;

FIGS. 3A and 3B illustrate examples of communications including channel contention procedures and acknowledgement requests between an AP and a STA that utilize alternate channels for acknowledgement messages in accordance with various aspects of the present disclosure;

FIGS. 4A and 4B illustrate examples of communications including channel contention procedures and acknowledgement requests between an AP and a STA that utilize alternate channels for acknowledgement messages in accordance with various aspects of the present disclosure;

FIGS. 5A and 5B illustrate examples of communications including channel contention procedures and acknowledgement requests between an AP and a STA that utilize alternate channels for acknowledgement messages in accordance with various aspects of the present disclosure;

FIG. 6 illustrates an example of communications including acknowledgement requests between an AP and a STA that utilize alternate channels for acknowledgement messages in accordance with various aspects of the present disclosure;

FIGS. 7-9 show block diagrams of wireless devices that support using alternate channels for acknowledgement messages in accordance with various aspects of the present disclosure;

FIG. 10 illustrates a block diagram of a system including a device that supports using alternate channels for acknowledgement messages in accordance with various aspects of the present disclosure;

FIG. 11 illustrates a block diagram of a system including an AP that supports alternate channels for acknowledgement messages in accordance with various aspects of the present disclosure; and

FIGS. 12-21 show flowcharts illustrating methods for using alternate channels for acknowledgement messages in accordance with various aspects of the present disclosure.

### DETAILED DESCRIPTION

The described features generally relate to improved systems, methods, and/or apparatus for acknowledging data frames in wireless communications. Wireless devices (e.g., STAs and APs) may have different transmit power capabilities. In certain scenarios, a range for which an ACK frame, a negative acknowledgment (NACK) frame, or a BA frame may be transmitted in response to a data frame (e.g., PPDU frame) may be smaller than the range of the data frame. Additionally, ACK, NACK, and BA frame transmissions are typically performed without any channel contention procedure. As data frames are wirelessly transmitted at higher frequencies and greater rates, certain wireless devices (e.g., STAs and APs) and/or certain wireless transmission environments may not be sufficiently designed to efficiently or effectively acknowledge receipt of such data frames. Accordingly, various techniques are described for using alternate channels for acknowledgement messages.

In accordance with aspects of the disclosure, acknowledgement messages may be transmitted via an alternate channel that is different (e.g., having a different frequency sub-band and/or bandwidth) from the channel in which the data frame is transmitted. In some examples, an additional acknowledgment message may be transmitted via the same channel or primary channel as the data frame. When the additional acknowledgement message is transmitted on the same channel (e.g., the primary channel) as the data frame, the additional acknowledgement message may be transmitted at a lower power than the acknowledgement message transmitted via the alternate channel (or at a power lower than what an ACK, NACK, or BA would typically be transmitted per the relevant IEEE 8002.11 specification).

In some examples, acknowledgment messages may be transmitted via the alternate channel immediately in response to a received data frame, or may be transmitted via the alternate channel in a delayed response and/or a solicited manner from a data transmitting wireless communication device (e.g., AP or data transmitting STA). In accordance with certain aspects, the primary (or first) channel, via which the data frame may be transmitted, may be an IEEE 802.1 lax channel, which can operate on a channel or frequency sub-band in the 2.4 GHz and 5 GHz spectra. The alternative (or second) channel may be an IEEE 802.11ah channel, and the acknowledgement messages may have a corresponding physical (PHY) format that is compatible with the IEEE 802.11ah specification. In this regard, IEEE 802.11ah can operate on a channel or frequency sub-band that is less than 1 GHz, and therefore may be subject to a lower propagation loss than the primary (or first) channel, via which the data frame may be transmitted. As such, the alternative (or second) channel may provide a longer acknowledgement message range than a similar acknowledgment message on a 2.4 or 5 GHz channel (for a same power). Additionally or alternatively, the alternate (or second) channel may enable a lower transmit power for the acknowledgement message for providing a same range as provided by a similar acknowledgment message transmitted on a 2.4 or 5 GHz channel, for example.

In accordance with some aspects, the primary (or first) channel, for which the data frame may be transmitted, may be an IEEE 802.11ax channel, and the alternative (or second) channel may be an IEEE 802.1 lax channel that is a different IEEE 802.11ax channel (e.g., a lower frequency channel) than the primary (or first) channel. In this regard, interference associated with acknowledgment messages being transmitted via the primary (or first) channel can be mitigated. In accordance with other aspects, the primary (or first) channel, for which the data frame may be transmitted, may be an IEEE 802.11ad channel, which can operate on a channel or frequency sub-band in the 60 GHz spectra, and the alternative (or second) channel may be an IEEE 802.11ac channel, which can operate on a channel or frequency sub-band in the 5 GHz spectra. As such, a wireless system in accordance with example aspects of the present disclosure may include a wireless communication device (e.g., an AP or a STA) having an IEEE 802.11ad DL only channel and an IEEE 802.11ac UL channel that may be used for acknowledgment messaging.

In accordance with further aspects, the primary (or first) channel, for which the data frame may be transmitted, may be any wireless local area network (WLAN) channel, such as but not limited to an IEEE 802.11a channel, an IEEE 802.11b channel, an IEEE 802.11n channel, an IEEE 802.11ac channel, an IEEE 802.11ad channel, an IEEE 802.11ax channel, etc. The alternative (or second) channel may be a Long Term Evolution (LTE)/LTE-Advanced (LTE-A) wireless communication channel, and the acknowledgement messages may have a corresponding format that is compatible with LTE/LTE-A signaling specifications. In yet other aspects, the alternative (or second) channel may be associated with disparate network having distinct operational characteristics as compared to the network providing the primary (or first) channel on which the data frames are transmitted.

As provided in the examples herein, aspects of using alternate channels described in the present disclosure can solve various cost, power, interference, and range challenges associated with wireless communication devices (e.g., APs and STAs) transmitting and receiving data frames at higher WLAN frequencies, for example.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

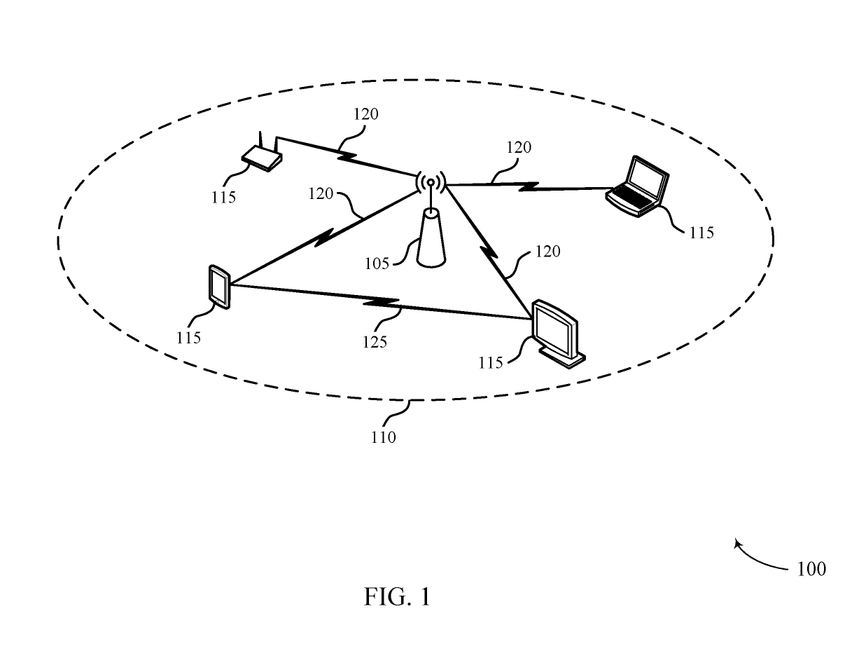

FIG. 1 illustrates a WLAN 100 (also known as a wireless fidelity (Wi-Fi) network) in accordance with various aspects of the present disclosure. The WLAN 100 may include an AP 105 and multiple associated STAs 115, which may represent devices such as mobile devices, smartphones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network may be able to communicate with one another through the AP 105. Also shown is a geographic coverage area 110 of the AP 105, which may represent a basic service area (BSA) of the WLAN 100.

Although not shown in FIG. 1, a STA 115 may be located in the intersection of more than one geographical coverage area 110 and may associate with more than one AP 105. A single AP 105 and an associated set of STAs 115 may be referred to as a BSS. An ESS is a set of connected BSSs. A distribution system (DS) (not shown) may be used to connect APs 105 in an ESS. In some cases, the geographic coverage area 110 of an AP 105 may be divided into sectors (also not shown). The WLAN 100 may include APs 105 of different types (e.g., metropolitan area, home network, etc.), with varying and overlapping geographic coverage areas 110. Two STAs 115 may also communicate directly via a direct wireless link 125 regardless of whether both STAs 115 are in the same geographic coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for PHY and medium access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

WLAN 100 may operate on two primary levels: the MAC of the data link layer and the PHY layer. The MAC sub-layer may include the distributed coordination function (DCF) and point coordination function (PCF). The DCF may be the basic access method, and may also be known as carrier sense multiple access with collision avoidance (CSMA/CA). In DCF, each STA 115 may access the network independently using a collision avoidance protocol. For example, a STA 115 may wait for a DCF Interframe Space (DIFS) plus a random backoff period prior to transmitting to check whether another STA 115 is using the channel. The DCF may be implemented in all STAs 115. PCF may be implemented in selected STAs 115. In PCF, a single AP 105 may coordinate the access for other STAs 115. DCF and PCF may operate concurrently within the same BSS. For example, the two access methods may alternate, with a contention free period (CFP) for PCF followed by a contention period (CP) for DCF. A hybrid coordination function (HCF) may also be used, in which different traffic types are assigned different access priorities.

In some cases, a STA 115 (or an additional AP 105) may be detectable by AP 105, but not by other STAs 115 in the geographic coverage area 110 of the AP 105. For example, one STA 115 may be at one end of the coverage area 110 of the AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS messaging may help mitigate a hidden node problem.

In some cases, a STA 115 or AP 105 may operate in a shared or unlicensed frequency spectrum. These devices may perform a clear channel assessment (CCA) prior to communicating in order to determine whether the channel is available. A CCA may include an energy detection procedure to determine whether there are any other active transmissions. For example, the device may infer that a change in a relative received signal strength (RSSI) of a power meter indicates that a channel is occupied. Specifically, signal power that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

In accordance with the present disclosure, STA 115 and AP 105 may be configured to use alternate channels for acknowledgment messaging. For example, STA 115 may receive a portion of a data frame from AP 105 via a primary channel, and may transmit an acknowledgement message (e.g., an ACK) via an alternate channel in response to the received data frame. The alternate channel is different from the primary channel, in accordance with certain aspects. For example, the alternate channel may operate on a different frequency sub-band and/or with a different bandwidth from the primary channel. Likewise, AP 105 may be configured to transmit a data frame via the primary channel to STA 115, and receive an acknowledgement message (e.g., an ACK) via the alternate channel from STA 115. In some examples, AP 105 and/or STA 115 may perform various channel contention procedures with respect to the alternate channel.

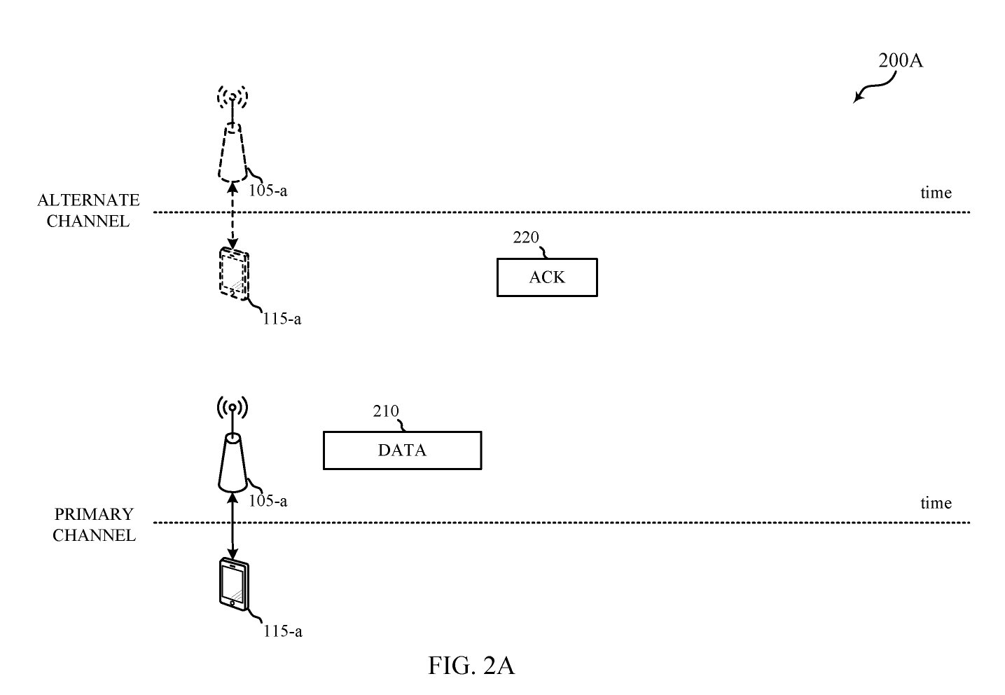

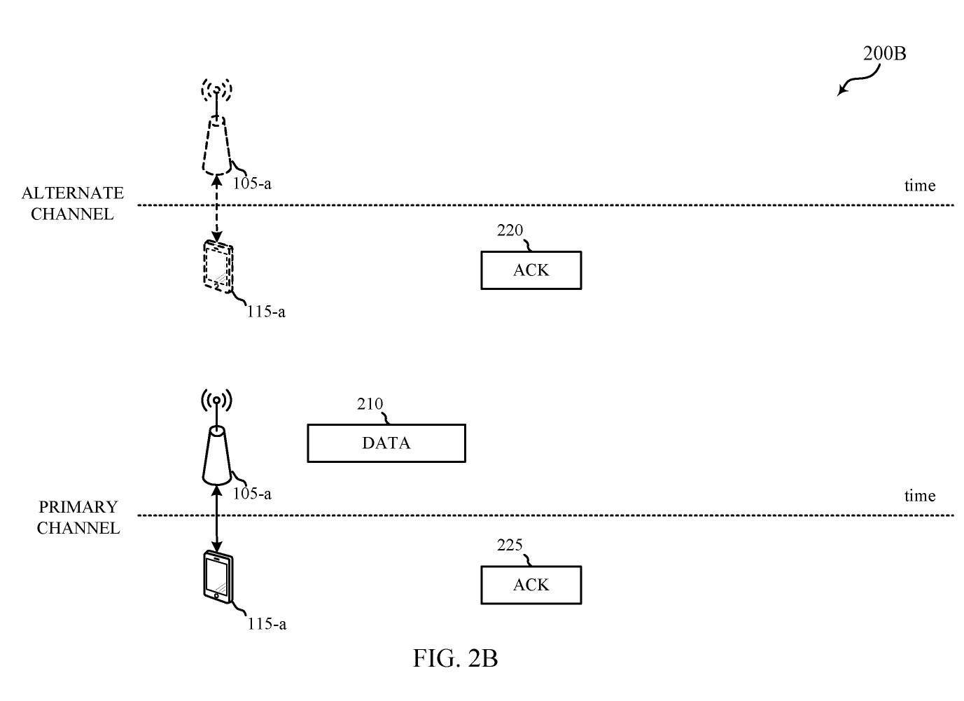

FIG. 2A illustrates an example of communications between an AP and a STA that utilize alternate channels for acknowledgement messages in accordance with various aspects of the present disclosure. Wireless communication system 200A may include STA 115-a and AP 105-a, which may be examples of STA 115 and AP 105 described with reference to FIG. 1.

The timeline of the primary and alternate channel of wireless communication system 200A can relate to divisions of time over which communications may be scheduled, such as but not limited to a frame or a subframe. Data frame 210 may be transmitted by AP 105-a via the primary channel to STA 115-a. STA 115-a may receive a portion of the data and wait to respond until the entire data frame 210 has been received. When the entire data frame 210 has been received by the STA 115-a, STA 115-a may transmit an ACK frame 220 (or appropriate acknowledgement message) via the alternate channel in response to the received data frame 210.

As described herein, the alternate channel may be different than primary channel. In some examples, the primary channel may operate in a WLAN frequency sub-band (e.g., an IEEE 802.11ac channel, an IEEE 802.11ad channel, an IEEE 802.11ax channel), and the alternate channel may operate in a non-WLAN frequency sub-band (e.g., an LTE/LTE-A wireless communication channel). In other examples, the primary channel may operate in a WLAN frequency sub-band (e.g., an IEEE 802.11ad channel), and the alternate channel may operate in a WLAN frequency sub-band (e.g., an IEEE 802.11ac channel) lower than the WLAN frequency sub-band of the primary channel.

In certain implementations, the ACK frame 220 may be transmitted in response to the received data frame irrespective of a state of the alternate channel (e.g., immediately upon or shortly after receiving the data frame 210). In this regard, the state of the alternate channel may comprise a clear-channel assessment (CCA) state and/or a net allocation vector (NAV) state. In some examples, the STA 115-a may transmit the ACK frame 220 within a short interframe space (SIFS) time after the data frame 210 has been received Depending on the integrity of the data received in data frame 210 (e.g., errors received during transmission), STA 115-a may transmit a NACK frame via the alternate channel as the acknowledgement message in response to the data frame 210.

FIG. 2B illustrates an example of communications between an AP and a STA that utilize alternate channels for acknowledgement messages in accordance with various aspects of the present disclosure. Wireless communication system 200B may include STA 115-a and AP 105-a, which may be examples of STA 115 and AP 105 described with reference to FIG. 1.

The timeline of the primary and alternate channel of wireless communication system 200B can relate to divisions of time over which communications may be scheduled, such as but not limited to a frame or a subframe. Data frame 210 may be transmitted by AP 105-a via the primary channel to STA 115-a. STA 115-a may receive a portion of the data and wait to respond until the entire data frame 210 has been received. When the entire data frame 210 has been received by the STA 115-a, STA 115-a may transmit an ACK frame 220 via the alternate channel and an ACK frame 225 via the primary channel in response to the received data frame 210.

As such, transmitting the ACK frame 225 via the primary channel may assist in maintaining timing and operation aspects associated with the particular 802.11 specification corresponding to the primary channel, AP 105-a and other associated equipment in of wireless communication system 200B. In some examples, STA 115-a may transmit the ACK frame 225 (e.g., a second or duplicate acknowledgement message) via the primary channel at a lower power level than the power level used to transmit the ACK frame 220 via the alternate channel.

To avoid potential interference issues with respect to ongoing transmissions via the alternate channel, a channel contention procedure may be performed by STA 115-a on the alternate channel after the data frame 210 has been received. Thus, although the ACK frame 225 may be sent immediately upon or shortly after receiving the data frame 210 via the primary channel, the ACK frame 220 may not be transmitted by STA 115-a until the channel contention procedure has been performed, and the STA 115-a has determined that the alternate channel is available to send the ACK frame 220. For example, STA 115-a may CCA of the alternate channel and win the alternate channel. The performed CCA may indicate that the alternate channel is idle for a PCF Interframe Space (PIFS) before the STA 115-a transmits the ACK frame 220. In some examples, the STA 115-a may also determine that a net allocation vector (NAV) state associated with the alternate channel is clear prior to transmitting the ACK frame 220.

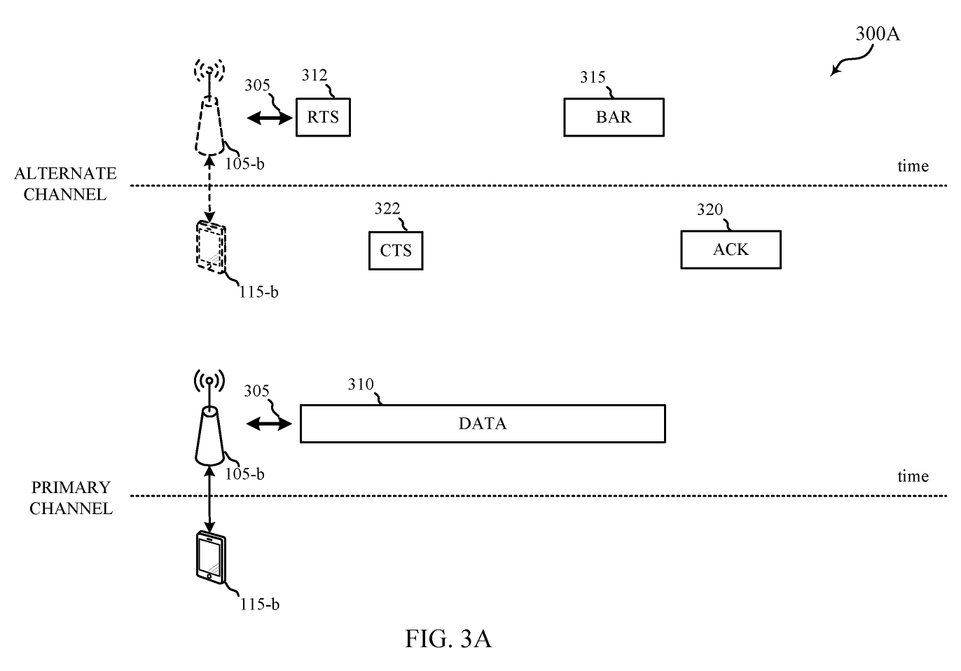

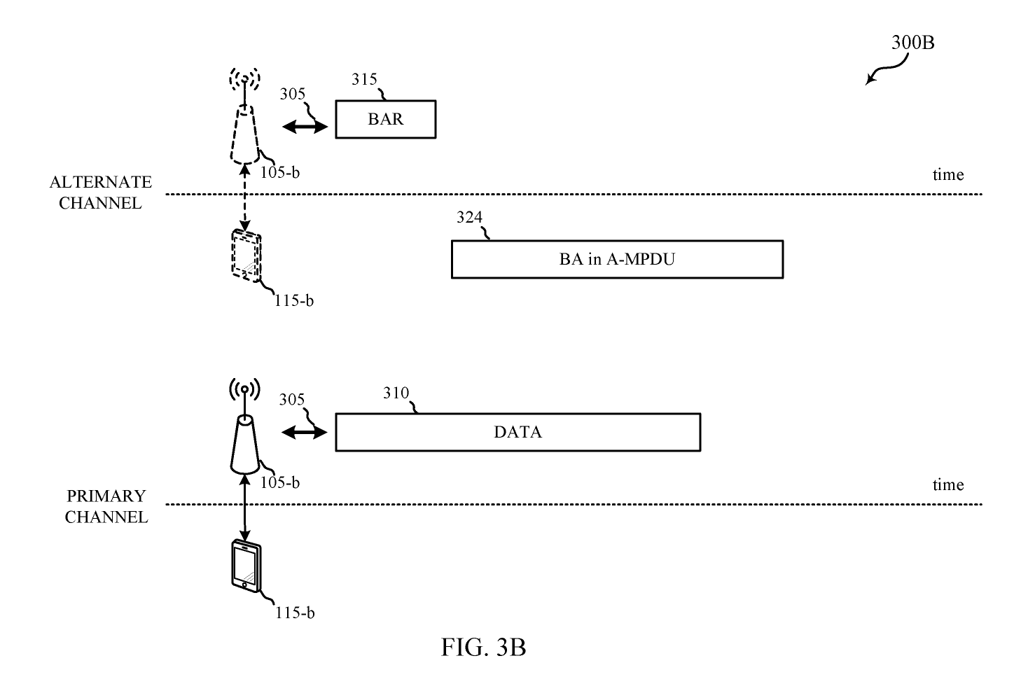

FIG. 3A illustrates an example of communications between an AP and a STA that utilize alternate channels for acknowledgement messages in accordance with various aspects of the present disclosure. Wireless communication system 300A may include STA 115-b and AP 105-b, which may be examples of STA 115 and AP 105 described with reference to FIG. 1.

The timeline of the primary and alternate channel of wireless communication system 300A can relate to divisions of time over which communications may be scheduled, such as but not limited to a frame or a subframe. In accordance with certain examples, AP 105-b may contend 305 on both the primary channel and the alternate channel. When the AP 105-b determines that the primary channel and the alternate channel are clear, the AP 105-b may transmit a RTS message 312 via the alternate channel to reserve the medium. The AP 105-b may transmit the data frame 310 with via the primary channel concurrently with or after transmitting the RTS message 312.

STA 115-b may respond to the RTS message 312 via the alternate channel by transmitting a CTS message 322 via the second channel. The AP 105-b may transmit a BAR message 315 via the alternate channel to the STA 115-b to solicit the acknowledgement message or messages from the STA 115-b. The BAR message 315 may be transmitted when a transmitted portion of the data frame 310 satisfies a transmission threshold. For example, the BAR message 315 may be transmitted by the AP 105-b to coincide with completion of the transmission of the data frame 310 or after the entirety of the data frame 310 has been sent. In this manner, the BAR message 315 may be transmitted at an appropriate time to immediately solicit an acknowledgement message from STA 115-b. As such, ACK frame 320 (e.g., a BA or a NACK or other appropriate acknowledgment message) may be accordingly transmitted via the alternate channel by STA 115-b.

FIG. 3B illustrates an example of communications between an AP and a STA that utilize alternate channels for acknowledgement messages in accordance with various aspects of the present disclosure. Wireless communication system 300B may include STA 115-b and AP 105-b, which may be examples of STA 115 and AP 105 described with reference to FIG. 1.

The timeline of the primary and alternate channel of wireless communication system 300B can relate to divisions of time over which communications may be scheduled, such as but not limited to a frame or a subframe. In accordance with other aspects, AP 105-b may contend 305 on both the primary channel and the alternate channel. When the AP 105-b determines that the primary channel and the alternate channel are clear, the AP 105-b may transmit a BAR message 315 via the alternate channel. The AP 105-b may transmit the data frame 310 via the primary channel concurrently with or after transmitting the BAR message 315. The AP 105-b may also transmit a request for a continuous response from STA 115-b via the second channel. As such, STA 115-b may transmit an aggregate medium access control (MAC) protocol data unit (AMPDU) via the alternate channel in response to the request for the continuous response.

It is to be appreciated that in some implementations of the examples illustrated in FIGS. 3A and 3B, AP 105-b may contend 305 only for the alternate channel, or may contend 305 only for the primary channel, or may not contend for either the alternate channel or the primary channel, depending on particular channel reserve policies and procedures associated with wireless communication systems 300A and 300B, for example.

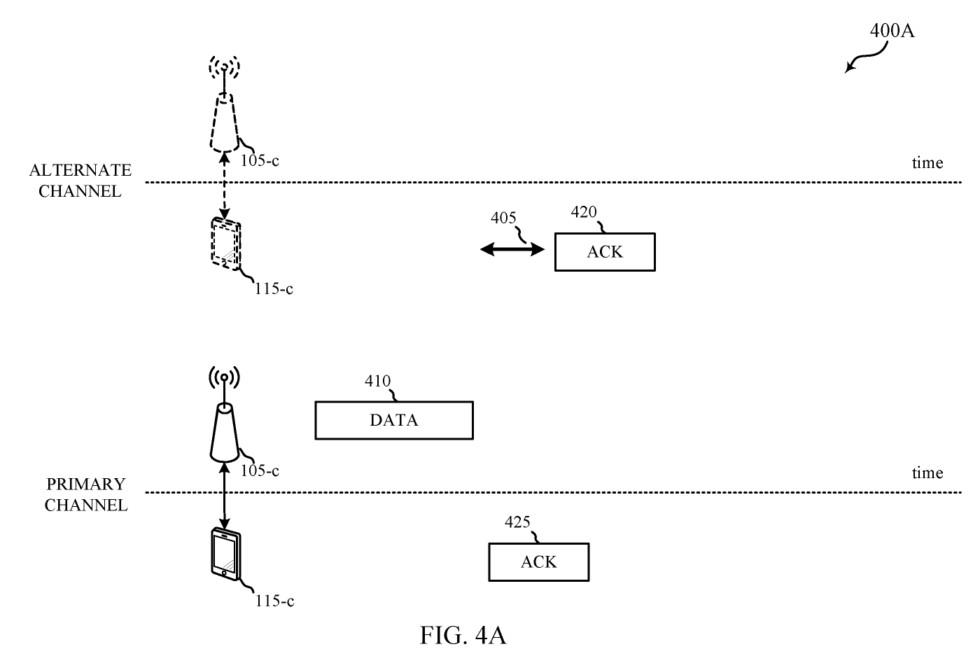

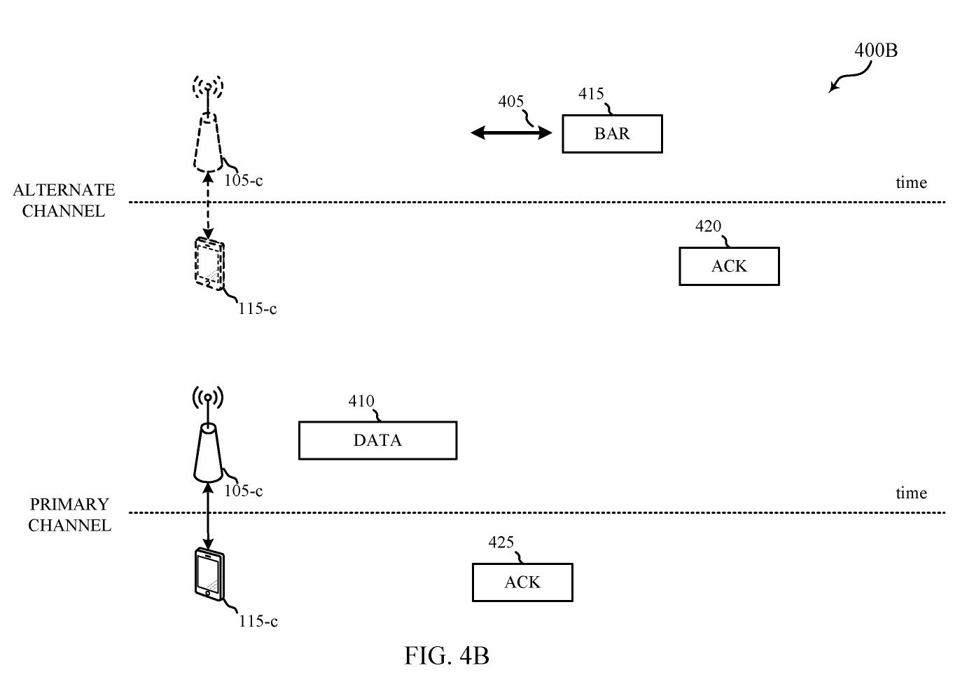

FIG. 4A illustrates an example of communications between an AP and a STA that utilize alternate channels for acknowledgement messages in accordance with various aspects of the present disclosure. Wireless communication system 400A may include STA 115-c and AP 105-c, which may be examples of STA 115 and AP 105 described with reference to FIG. 1.

The timeline of the primary and alternate channel of wireless communication system 400A can relate to divisions of time over which communications may be scheduled, such as but not limited to a frame or a subframe. In accordance with certain examples, AP 105-c may transmit the data frame 410 via the primary channel. Upon receiving the data frame 410, STA 115-c may contend 405 on the alternate channel. For example, STA 115-c may perform a channel contention procedure utilizing enhanced distributed channel access (EDCA) techniques. When the STA 115-c determines that the alternate channel is clear, the STA 115-c may transmit ACK frame 420, for example, using a high priority class if obtained by the channel contention procedure. In some examples, the STA 115-c may transmit an ACK frame 425 via the primary channel in response to the received data frame 410, while contending 405 on the alternate channel.

FIG. 4B illustrates an example of communications between an AP and a STA that utilize alternate channels for acknowledgement messages in accordance with various aspects of the present disclosure. Wireless communication system 400B may include STA 115-c and AP 105-c, which may be examples of STA 115 and AP 105 described with reference to FIG. 1.

The timeline of the primary and alternate channel of wireless communication system 400B can relate to divisions of time over which communications may be scheduled, such as but not limited to a frame or a subframe. In accordance with certain examples, AP 105-c may transmit the data frame 410 via the primary channel. AP 105-c may contend 405 on the alternate channel during the transmission of the data frame 410 via the primary channel or after transmission of the data frame 410 has been completed. In such examples, STA 115-c may wait until receiving the BAR 415 from the AP 105-c via the alternate channel before transmitting any acknowledgement messages. When the STA 115-c receives the BAR 415 from the AP 105-c, the STA 115-c may transmit the ACK frame 420. In some examples, the STA 115-c may transmit an ACK frame 425 via the primary channel in response to the received data frame 410, while waiting to receive the BAR 415 on the alternate channel.

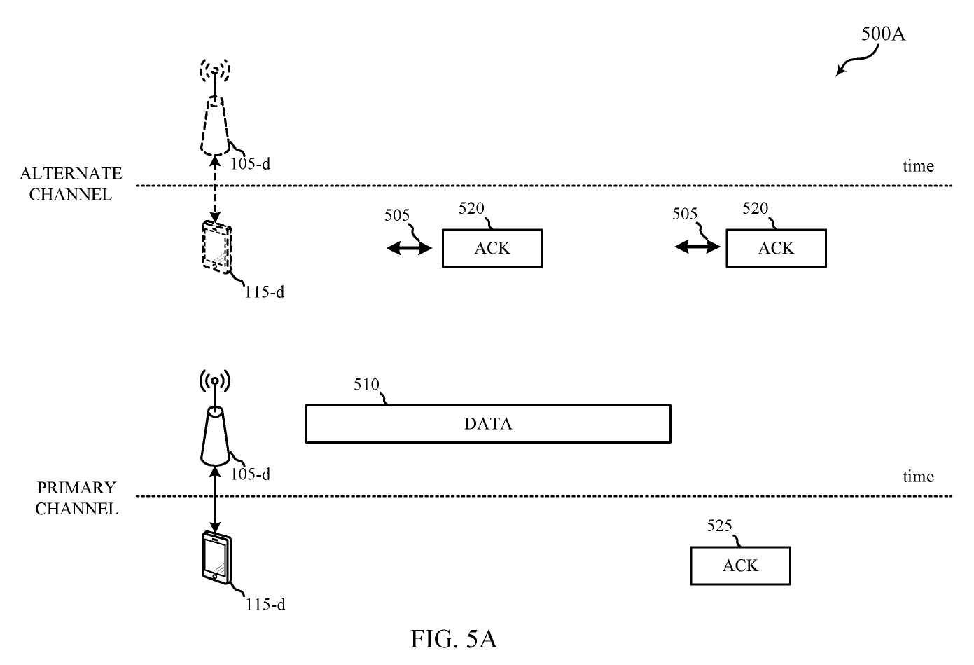

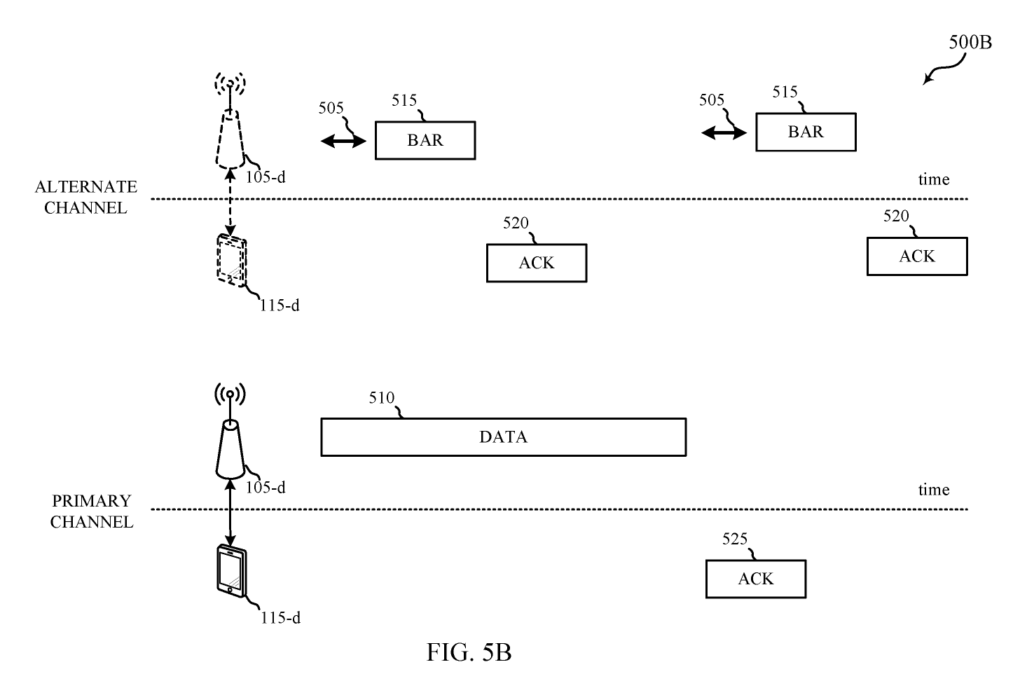

FIG. 5A illustrates an example of communications between an AP and a STA that utilize alternate channels for acknowledgement messages in accordance with various aspects of the present disclosure. Wireless communication system 500A may include STA 115-d and AP 105-d, which may be examples of STA 115 and AP 105 described with reference to FIG. 1.

The timeline of the primary and alternate channel of wireless communication system 500A can relate to divisions of time over which communications may be scheduled, such as but not limited to a frame or a subframe. In accordance with certain examples, AP 105-d may transmit the data frame 510 via the primary channel. The STA 115-d may decode a portion of the received data frame 510 prior to an entirety of the data frame 510 being received. Upon receiving and decoding the portion of the data frame 510, STA 115-d may contend 505 on the alternate channel. When the STA 115-d determines that the alternate channel is clear, the STA 115-d may transmit ACK frame 520 (e.g., a partial acknowledgement message).

In this regard, an early channel contention and acknowledgement message transmission may be beneficial in examples where long or extended data frames are transmitted by the AP 105-d via the primary channel. Upon receiving an entirety of the data frame 510, STA 115-d may again contend 505 on the alternate channel. When the STA 115-d determines that the alternate channel is clear, the STA 115-d may transmit ACK frame 520 (e.g., a subsequent acknowledgment message). In some examples, the STA 115-d may transmit an ACK frame 525 via the primary channel in response to the received data frame 510, while contending 505 on the alternate channel and transmitting the ACK frame 520 (e.g., the subsequent acknowledgment message).

FIG. 5B illustrates an example of communications between an AP and a STA that utilize alternate channels for acknowledgement messages in accordance with various aspects of the present disclosure. Wireless communication system 500B may include STA 115-d and AP 105-d, which may be examples of STA 115 and AP 105 described with reference to FIG. 1.

The timeline of the primary and alternate channel of wireless communication system 500B can relate to divisions of time over which communications may be scheduled, such as but not limited to a frame or a subframe. In accordance with certain examples, AP 105-d may transmit the data frame 510 via the primary channel. AP 105-d may contend 505 on the alternate channel early during the transmission of the data frame 510 via the primary channel, and may transmit a first BAR 515. When the STA 115-d receives the first BAR 515 from the AP 105-d, the STA 115-d may transmit the ACK frame 520 (e.g., a partial acknowledgement message).

In this regard, an early channel contention and acknowledgement message transmission may be beneficial in examples where long or extended data frames are transmitted by the AP 105-d via the primary channel. The transmitter may use the early ACK/NACK information to schedule immediate retransmissions or other redundancy transmissions, for example. Upon transmitting an entirety of the data frame 510, AP 105-d may again contend 505 on the alternate channel. When the AP 105-d determines that the alternate channel is clear, the AP 105-d may transmit a second BAR 515. When the STA 115-d receives the second BAR 515 from the AP 105-d, the STA 115-d may transmit ACK frame 520 (e.g., a subsequent acknowledgment message). In some examples, the STA 115-d may transmit an ACK frame 525 via the primary channel in response to the received data frame 510, while waiting for the second BAR 515 from the AP 105-d.

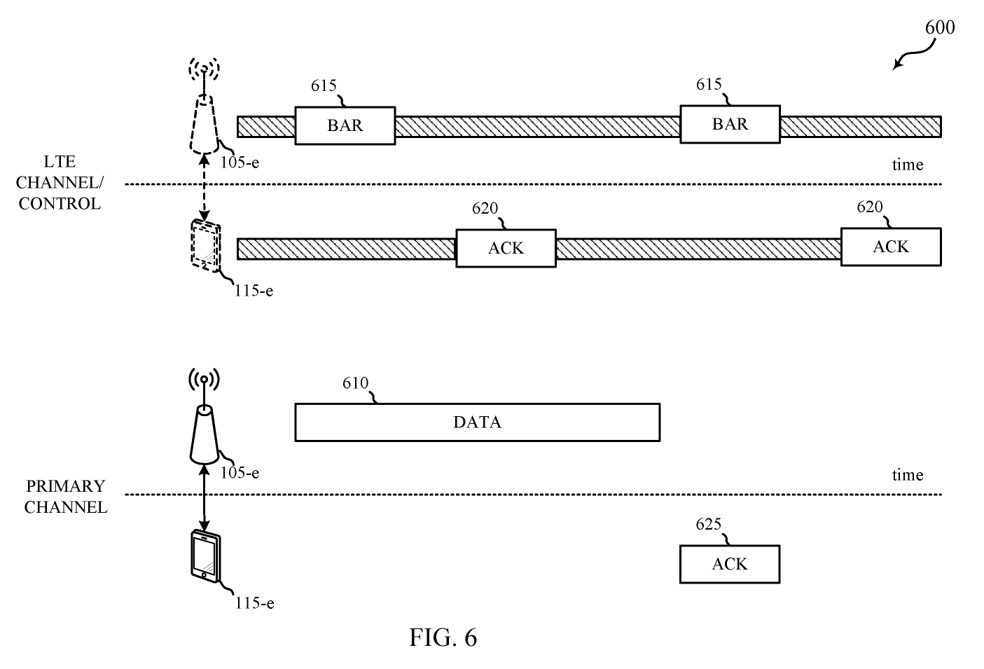

FIG. 6 illustrates an example of communications between an AP and a STA that utilize alternate channels for acknowledgement messages in accordance with various aspects of the present disclosure. Wireless communication system 600 may include STA 115-e and AP 105-e, which may be examples of STA 115 and AP 105 described with reference to FIG. 1.

The timeline of the primary channel of wireless communication system 600 can relate to divisions of time over which communications may be scheduled, such as but not limited to a frame or a subframe. The timeline of the LTE channel/UL and DL control channel (e.g., used as an alternate channel) can relate to divisions of time over which communications using UL and DL transmissions may be scheduled. In accordance with certain examples, AP 105-e may transmit the data frame 610 via the primary channel. AP 105-e may schedule and transmit several BARs 615 in accordance with LTE/LTE-A signaling specifications. STA 115-e may receive the BARs 615 from the AP 105-e, and the STA 115-e may schedule and transmit the corresponding ACK frames 620 (or other appropriate acknowledgement messages) in accordance with LTE/LTE-A signaling specifications. In such examples, scheduling of the LTE channel/UL and DL control channels and timing of the BARs 615 and ACK frames 620 may not be aligned with the reception of the data frame 610.

In this regard, acknowledgment messaging may utilize technologies other than IEEE 802.11 in accordance with some aspects. It is to be further appreciated that the acknowledgement messaging examples described herein (e.g., alternate channels for ACK, NACK, BAR, BA exchanges) can be applied to other request/response exchange, such as but not limited to channel sounding and feedback procedures. For example, a channel sounding procedure in accordance with aspects of the disclosure may include utilizing null data packet (NDP) or NDP announcement (NDPA) techniques on the primary channel, and transmitting channel state information (CSI) over the alternate channel.

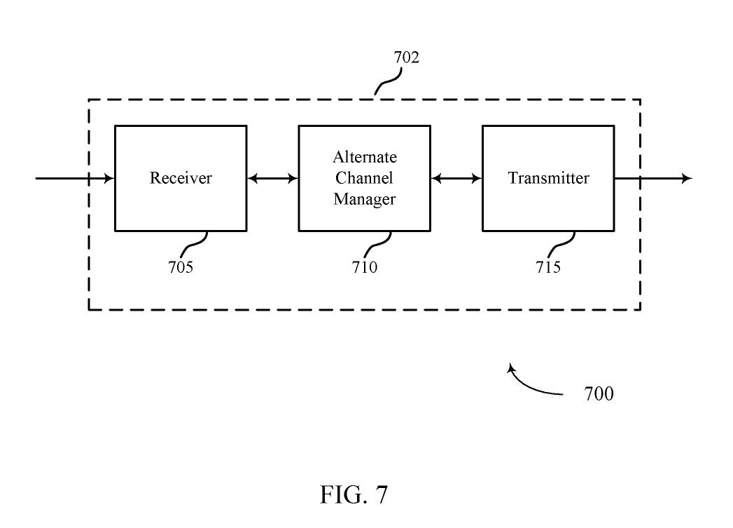

FIG. 7 shows a block diagram 700 of a wireless device 702 configured for using alternate channels for acknowledgement messaging in accordance with various aspects of the present disclosure. Wireless device 702 may be an example of aspects of a device 115 described with reference to FIGS. 1-6. Wireless device 702 may include a receiver 705, an alternate channel manager 710, or a transmitter 715. Wireless device 702 may also include a processor. Each of these components may be in communication with each other.

The receiver 705 may receive information such as packets, user data, or control information associated with various information channels (e.g., control channels, data channels, and information related to alternate channels for acknowledgement messages, etc.). Information may be passed on to the alternate channel manager 710, and to other components of wireless device 702.

The alternate channel manager 710 may transmit an acknowledgement message (e.g., an ACK, a NACK, or BA) via an alternate channel, different from the primary channel, in response to a received data frame as described with reference to FIGS. 2-6.

The transmitter 715 may transmit signals received from other components of wireless device 702. In some examples, the transmitter 715 may be collocated with the receiver 705 in a transceiver module. The transmitter 715 may include a single antenna, or it may include a plurality of antennas.

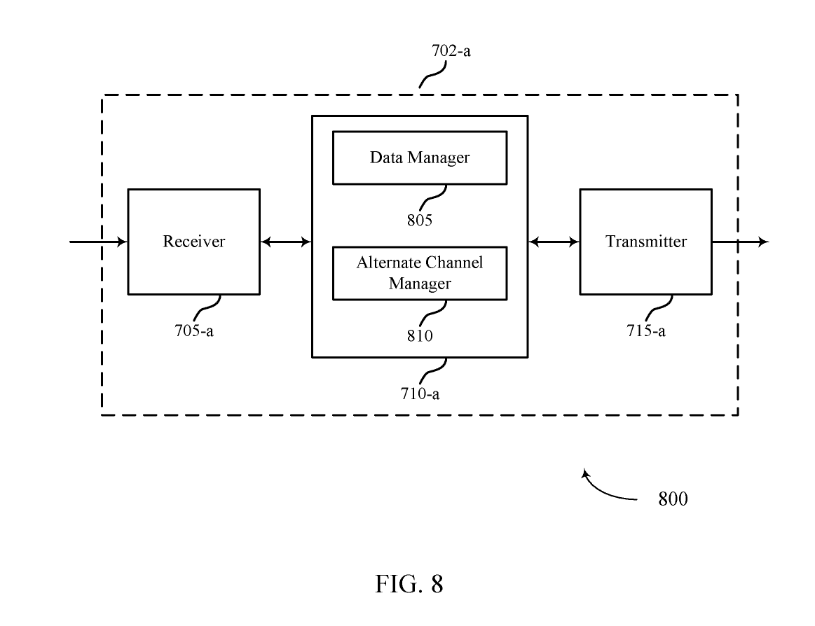

FIG. 8 shows a block diagram 800 of a wireless device 702-a for utilizing alternate channels for acknowledgement messaging in accordance with various aspects of the present disclosure. Wireless device 702-a may be an example of aspects of a wireless device 702, an AP 105, or a STA 115 described with reference to FIGS. 1-7. Wireless device 702-a may include a receiver 705-a, an alternate channel manager 710-a, or a transmitter 715-a. Wireless device 702-a may also include a processor. Each of these components may be in communication with each other. The alternate channel manager 710-a may also include a data manager 805, and an alternate channel manager 810.

The receiver 705-a may receive information which may be passed on to alternate channel manager 710-a, and to other components of wireless device 702-a. The alternate channel manager 710-a may perform the operations described with reference to FIG. 7. The transmitter 715-a may transmit signals received from other components of wireless device 702-a.

The data manager 805 may receive the data frame from an AP 105 or STA 115 via a primary channel as described with reference to FIGS. 2-6. The data manager 805 may also decode the received data frame.

The alternate channel manager 810 may transmit an acknowledgement message (e.g., an ACK, a NACK, or BA) via an alternate channel, different from the primary channel, as described with reference to FIGS. 2-6. The alternate channel manager 810 may also receive an acknowledgement message via the alternate channel, different from the primary channel in response to a data frame transmitted on the primary channel. The alternate channel manager 810 may also transmit a BAR message via the alternate channel to solicit acknowledgement messages.

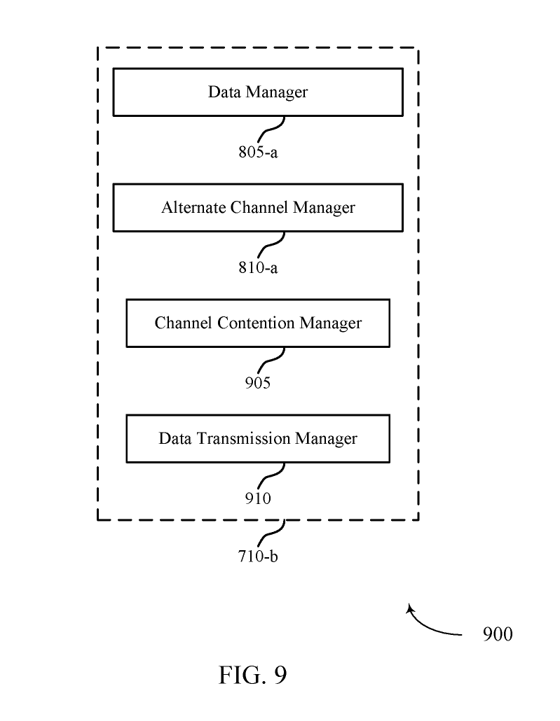

FIG. 9 shows a block diagram 900 of an alternate channel manager 710-b which may be a component of a wireless device 702 or a wireless device 702-a for using alternate channels for acknowledgement messaging in accordance with various aspects of the present disclosure. The alternate channel manager 710-b may be an example of aspects of an alternate channel manager 710 described with reference to FIGS. 7-8. The alternate channel manager 710-b may include a data manager 805-a, and an alternate channel manager 810-a. Each of these modules may perform the functions described with reference to FIG. 8. The alternate channel manager 710-b may also include a channel contention manager 905, and a data transmission manager 910. The channel contention manager 905 may perform channel contention procedures as described with reference to FIGS. 2-6. The data transmission manager 910 may transmit a data frame via a primary channel as described with reference to FIGS. 2-6.

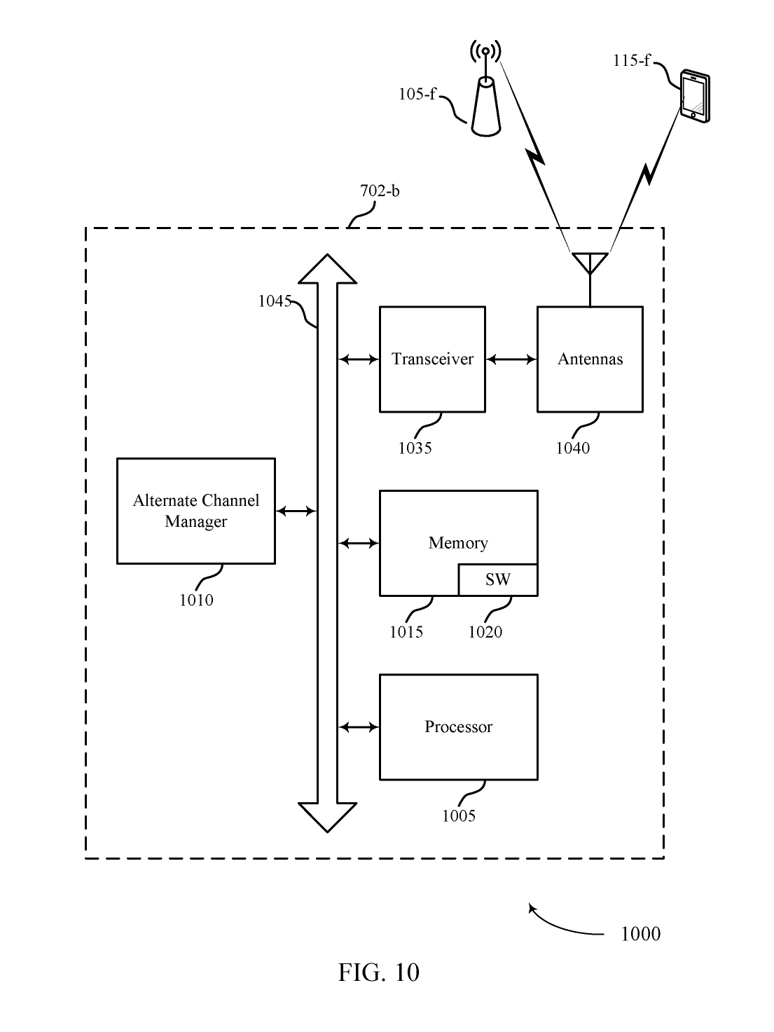

FIG. 10 shows a diagram of a system 1000 including a wireless device 702-b configured for using alternate channels for acknowledgement messaging in accordance with various aspects of the present disclosure. System 1000 may include wireless device 702-b, which may be an example of a wireless device 702, a wireless device 702-a, or a device 115 described with reference to FIGS. 1, 2, and 7-9. Wireless device 702-b may include an alternate channel manager 1010, which may be an example of an alternate channel manager 710 described with reference to FIGS. 7-9. Wireless device 702-b may also include components for bi-directional voice and data communications including components for transmitting communications and components for receiving communications. For example, wireless device 702-b may communicate bi-directionally with AP 105-f or STA 115-f.

Wireless device 702-b may also include a processor 1005, and memory 1015 (including software (SW)) 1020, a transceiver 1035, and one or more antenna(s) 1040, each of which may communicate, directly or indirectly, with one another (e.g., via buses 1045). The transceiver 1035 may communicate bi-directionally, via the antenna(s) 1040 or wired or wireless links, with one or more networks, as described above. For example, the transceiver 1035 may communicate bi-directionally with an AP 105-f or STA 115-f. The transceiver 1035 may include a modem to modulate the packets and provide the modulated packets to the antenna(s) 1040 for transmission, and to demodulate packets received from the antenna(s) 1040. While wireless device 702-b may include a single antenna 1040, wireless device 702-b may also have multiple antennas 1040 capable of concurrently transmitting or receiving multiple wireless transmissions.

The memory 1015 may include random access memory (RAM) and read only memory (ROM). The memory 1015 may store computer-readable, computer-executable software/firmware code 1020 including instructions that, when executed, cause the processor 1005 to perform various functions described herein (e.g., alternate channels for acknowledgement messages, etc.). Alternatively, the software/firmware code 1020 may not be directly executable by the processor 1005 but cause a computer (e.g., when compiled and executed) to perform functions described herein. The processor 1005 may include an intelligent hardware device, (e.g., a central processing unit (CPU), a microcontroller, an application specific integrated circuit (ASIC), etc.)

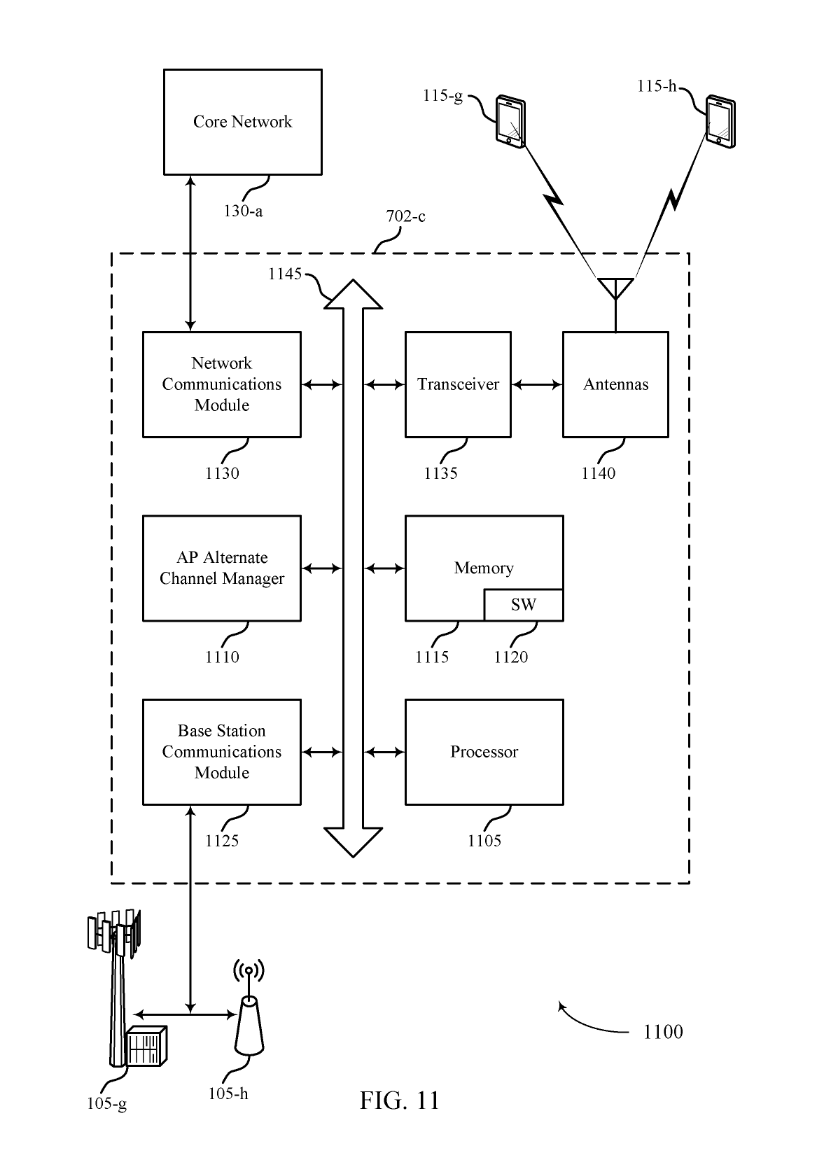

FIG. 11 shows a diagram of a system 1100 including an AP 105 configured for using alternate channels for acknowledgement messaging in accordance with various aspects of the present disclosure. System 1100 may include wireless device 702-c, which may be an example of a wireless device 702-a, a wireless device 702-b, or an AP 105 described with reference to FIGS. 1, 2, and 8-10. wireless device 702-c may include an AP alternate channel manager 1110, which may be an example of an AP alternate channel manager 1110 described with reference to FIGS. 8-10. Wireless device 702-c may also include components for bi-directional voice and data communications including components for transmitting communications and components for receiving communications. For example, wireless device 702-c may communicate bi-directionally with AP 105-g or AP 105-h.

In some cases, wireless device 702-c may have one or more wired backhaul links. Wireless device 702-c may have a wired backhaul link (e.g., 51 interface, etc.) to the core network 130. wireless device 702-c may also communicate with other APs 105, such as AP 105-g and AP 105-h via inter-AP backhaul links. Each of the APs 105 may communicate with STAs 115 using the same or different wireless communications technologies. In some cases, wireless device 702-c may communicate with other APs such as 105-g or 105-h utilizing AP communications module 1125. In some examples, AP communications module 1125 may provide an X2 interface within an LTE/LTE-A wireless communication network technology to provide communication between some of the APs 105. In some cases, wireless device 702-c may communicate with the core network 130 through network communications module 1130.

The wireless device 702-c may include a processor 1105, memory 1115 (including software (SW) 1120), transceiver 1135, and antenna(s) 1140, which each may be in communication, directly or indirectly, with one another (e.g., over bus system 1145). The transceiver 1135 may be configured to communicate bi-directionally, via the antenna(s) 1140, with the STAs 115, which may be multi-mode devices. The transceiver 1135 (or other components of the wireless device 702-c) may also be configured to communicate bi-directionally, via the antennas 1140, with one or more APs (not shown). The transceiver 1135 may include a modem configured to modulate the packets and provide the modulated packets to the antennas 1140 for transmission, and to demodulate packets received from the antennas 1140. The wireless device 702-c may include multiple transceivers 1135, each with one or more associated antennas 1140. The transceiver may be an example of a combined receiver 705 and transmitter 715 of FIG. 7.

The memory 1115 may include RAM and ROM. The memory 1115 may also store computer-readable, computer-executable software code 1120 containing instructions that are configured to, when executed, cause the processor 1105 to perform various functions described herein (e.g., alternate channels for acknowledgement messages, selecting coverage enhancement techniques, call processing, database management, message routing, etc.). Alternatively, the software 1120 may not be directly executable by the processor 1105 but be configured to cause the computer, e.g., when compiled and executed, to perform functions described herein. The processor 1105 may include an intelligent hardware device, e.g., a CPU, a microcontroller, an ASIC, etc. The processor 1105 may include various special purpose processors such as encoders, queue processing modules, base band processors, radio head controllers, digital signal processor (DSPs), and the like.

The AP communications module 1125 may manage communications with other APs 105. In some cases, a communications management module may include a controller or scheduler for controlling communications with STAs 115 in cooperation with other APs 105. For example, the AP communications module 1125 may coordinate scheduling for transmissions to STAs 115 for various interference mitigation techniques such as beamforming or joint transmission.

The components of wireless device 702, 702-a, 702-b, 702-c and alternate channel manager 710 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

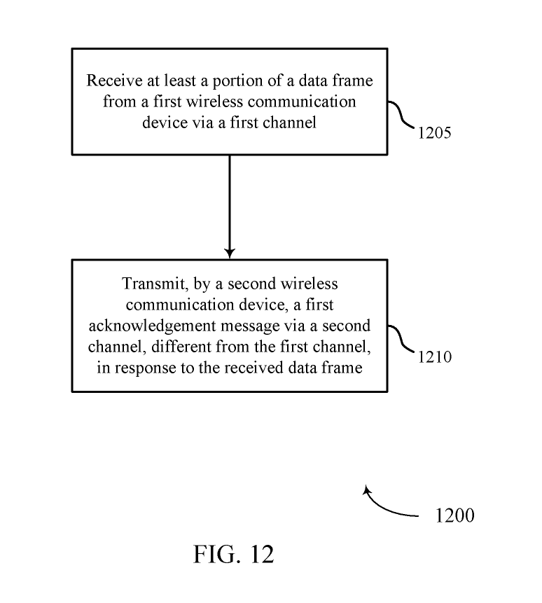

FIG. 12 shows a flowchart illustrating a method 1200 for using alternate channels for acknowledgement messaging in accordance with various aspects of the present disclosure. The operations of method 1200 may be implemented by a wireless communication device or its components as described with reference to FIGS. 1-11. For example, the operations of method 1200 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware.

At block 1205, wireless communication device may receive at least a portion of a data frame from a first wireless communication device via a first channel as described with reference to FIGS. 2-6. In certain examples, the operations of block 1205 may be performed by the data manager 805 as described with reference to FIG. 8.

At block 1210, wireless communication device may transmit a first acknowledgement message via a second channel, different from the first channel, in response to the received data frame as described with reference to FIGS. 2-6. In certain examples, the operations of block 1210 may be performed by the alternate channel manager 810 as described with reference to FIG. 8.

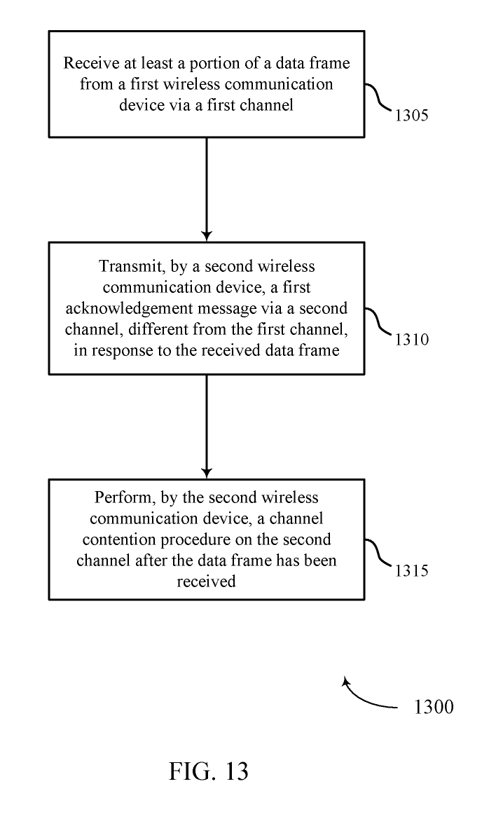

FIG. 13 shows a flowchart illustrating a method 1300 for using alternate channels for acknowledgement messaging in accordance with various aspects of the present disclosure. The operations of method 1300 may be implemented by a wireless communication device or its components as described with reference to FIGS. 1-11. For example, the operations of method 1300 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1300 may also incorporate aspects of method 1200 of FIG. 12.

At block 1305, the wireless communication device may receive at least a portion of a data frame from a first wireless communication device via a first channel as described with reference to FIGS. 2-6. In certain examples, the operations of block 1305 may be performed by the data manager 805 as described with reference to FIG. 8.

At block 1310, the wireless communication device may transmit a first acknowledgement message via a second channel, different from the first channel, in response to the received data frame as described with reference to FIGS. 2-6. In certain examples, the operations of block 1310 may be performed by the alternate channel manager 810 as described with reference to FIG. 8.

At block 1315, the wireless communication device may perform a channel contention procedure on the second channel after the data frame has been received as described with reference to FIGS. 2-6. In certain examples, the operations of block 1315 may be performed by the channel contention manager 905 as described with reference to FIG. 9.

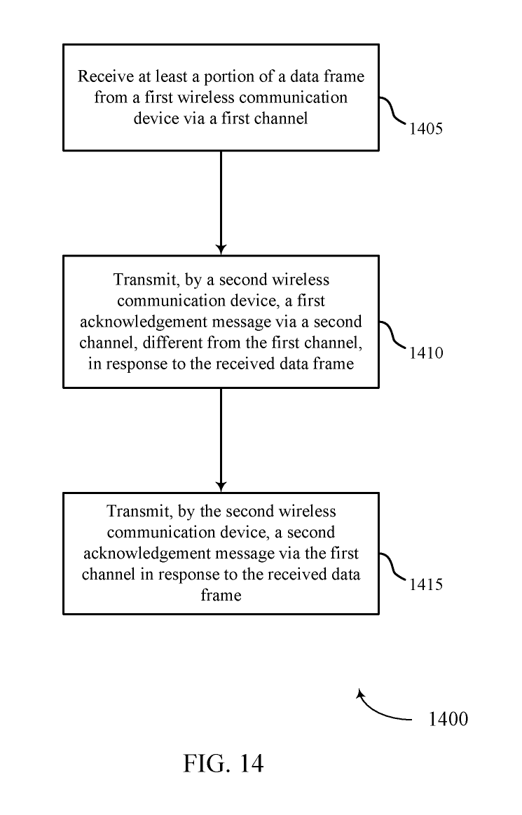

FIG. 14 shows a flowchart illustrating a method 1400 for using alternate channels for acknowledgement messaging in accordance with various aspects of the present disclosure. The operations of method 1400 may be implemented by a wireless communication device or its components as described with reference to FIGS. 1-11. For example, the operations of method 1400 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1400 may also incorporate aspects of methods 1200, and 1300 of FIGS. 12-13.

At block 1405, the wireless communication device may receive at least a portion of a data frame from a first wireless communication device via a first channel as described with reference to FIGS. 2-6. In certain examples, the operations of block 1405 may be performed by the data manager 805 as described with reference to FIG. 8.

At block 1410, the wireless communication device may transmit a first acknowledgement message via a second channel, different from the first channel, in response to the received data frame as described with reference to FIGS. 2-6. In certain examples, the operations of block 1410 may be performed by the alternate channel manager 810 as described with reference to FIG. 8.

At block 1415, the wireless communication device may transmit a second acknowledgement message via the first channel in response to the received data frame as described with reference to FIGS. 2-6. In certain examples, the operations of block 1415 may be performed by the data manager 805 as described with reference to FIG. 8.

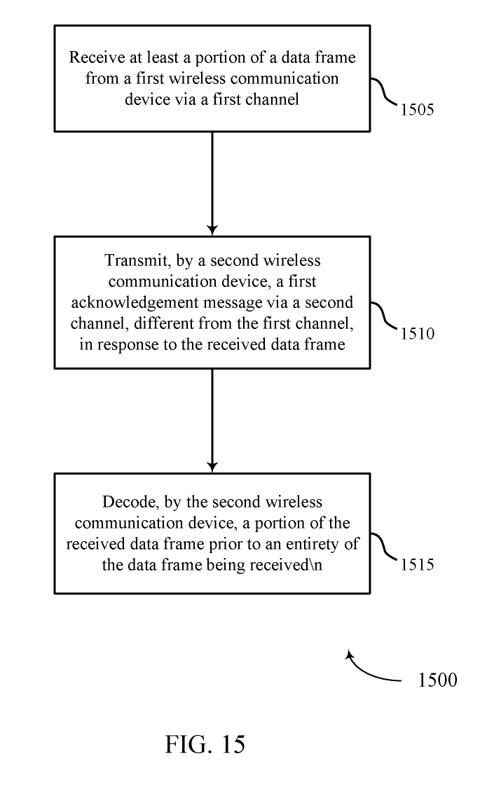

FIG. 15 shows a flowchart illustrating a method 1500 for using alternate channels for acknowledgement messaging in accordance with various aspects of the present disclosure. The operations of method 1500 may be implemented by a wireless communication device or its components as described with reference to FIGS. 1-11. For example, the operations of method 1500 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1500 may also incorporate aspects of methods 1200, 1300, and 1400 of FIGS. 12-14.

At block 1505, the wireless communication device may receive at least a portion of a data frame from a first wireless communication device via a first channel as described with reference to FIGS. 2-6. In certain examples, the operations of block 1505 may be performed by the data manager 805 as described with reference to FIG. 8.

At block 1510, the wireless communication device may transmit a first acknowledgement message via a second channel, different from the first channel, in response to the received data frame as described with reference to FIGS. 2-6. In certain examples, the operations of block 1510 may be performed by the alternate channel manager 810 as described with reference to FIG. 8.

At block 1515, the wireless communication device may decode a portion of the received data frame prior to an entirety of the data frame being received as described with reference to FIGS. 2-6. In certain examples, the operations of block 1515 may be performed by the data manager 805 as described with reference to FIG. 8.

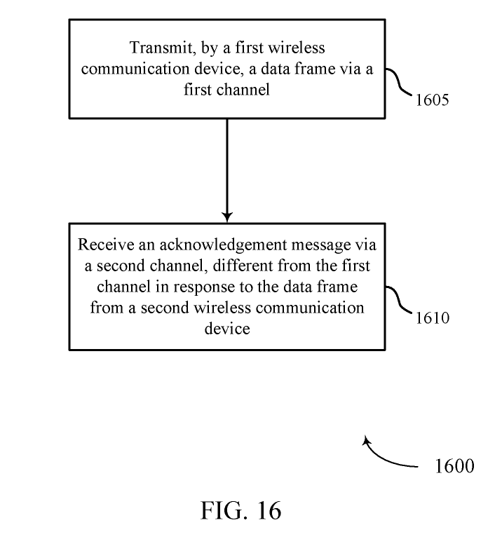

FIG. 16 shows a flowchart illustrating a method 1600 for using alternate channels for acknowledgement messaging in accordance with various aspects of the present disclosure. The operations of method 1600 may be implemented by a wireless communication device or its components as described with reference to FIGS. 1-11. For example, the operations of method 1600 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1600 may also incorporate aspects of methods 1200, 1300, 1400, and 1500 of FIGS. 12-15.

At block 1605, the wireless communication device may transmit a data frame via a first channel as described with reference to FIGS. 2-6. In certain examples, the operations of block 1605 may be performed by the data transmission manager 910 as described with reference to FIG. 9.

At block 1610, the wireless communication device may receive an acknowledgement message via a second channel, different from the first channel in response to the data frame from a second wireless communication device as described with reference to FIGS. 2-6. In certain examples, the operations of block 1610 may be performed by the alternate channel manager 810 as described with reference to FIG. 8.

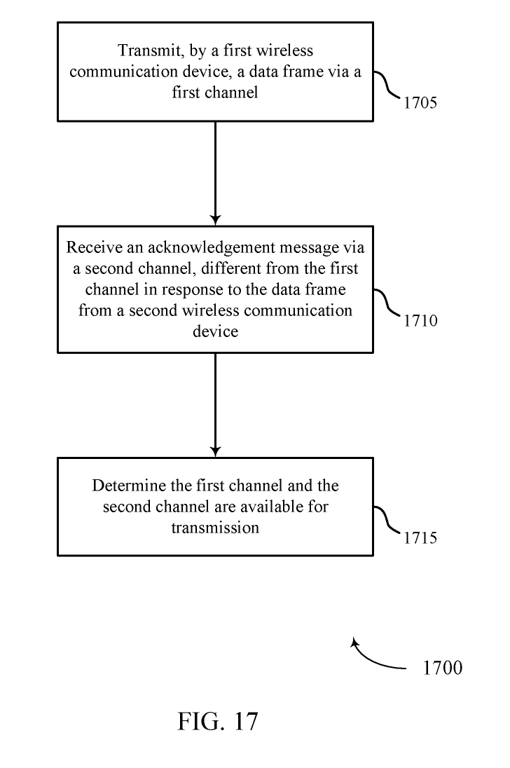

FIG. 17 shows a flowchart illustrating a method 1700 for using alternate channels for acknowledgement messaging in accordance with various aspects of the present disclosure. The operations of method 1700 may be implemented by a wireless communication device or its components as described with reference to FIGS. 1-11. For example, the operations of method 1700 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1700 may also incorporate aspects of methods 1200, 1300, 1400, 1500, and 1600 of FIGS. 12-16.

At block 1705, the wireless communication device may transmit a data frame via a first channel as described with reference to FIGS. 2-6. In certain examples, the operations of block 1705 may be performed by the data transmission manager 910 as described with reference to FIG. 9.

At block 1710, the wireless communication device may receive an acknowledgement message via a second channel, different from the first channel in response to the data frame from a second wireless communication device as described with reference to FIGS. 2-6. In certain examples, the operations of block 1710 may be performed by the alternate channel manager 810 as described with reference to FIG. 8.

At block 1715, the wireless communication device may determine the first channel and the second channel are available for transmission as described with reference to FIGS. 2-6. In certain examples, the operations of block 1715 may be performed by the channel contention manager 905 as described with reference to FIG. 9.

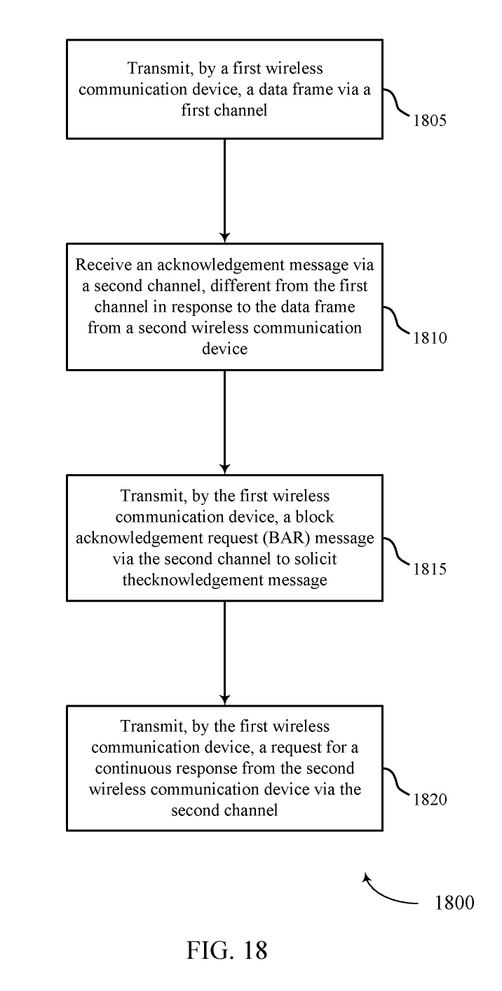

FIG. 18 shows a flowchart illustrating a method 1800 for using alternate channels for acknowledgement messaging in accordance with various aspects of the present disclosure. The operations of method 1800 may be implemented by a wireless communication device or its components as described with reference to FIGS. 1-11. For example, the operations of method 1800 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1800 may also incorporate aspects of methods 1200, 1300, 1400, 1500, 1600, and 1700 of FIGS. 12-17.

At block 1805, the wireless communication device may transmit a data frame via a first channel as described with reference to FIGS. 2-6. In certain examples, the operations of block 1805 may be performed by the data transmission manager 910 as described with reference to FIG. 9.

At block 1810, the wireless communication device may receive an acknowledgement message via a second channel, different from the first channel in response to the data frame from a second wireless communication device as described with reference to FIGS. 2-6. In certain examples, the operations of block 1810 may be performed by the alternate channel manager 810 as described with reference to FIG. 8.

At block 1815, the wireless communication device may transmit a block acknowledgement request (BAR) message via the second channel to solicit the acknowledgement message as described with reference to FIGS. 2-6. In certain examples, the operations of block 1815 may be performed by the alternate channel manager 810 as described with reference to FIG. 8.

At block 1820, the wireless communication device may transmit a request for a continuous response from the second wireless communication device via the second channel as described with reference to FIGS. 2-6. In certain examples, the operations of block 1820 may be performed by the alternate channel manager 810 as described with reference to FIG. 8.

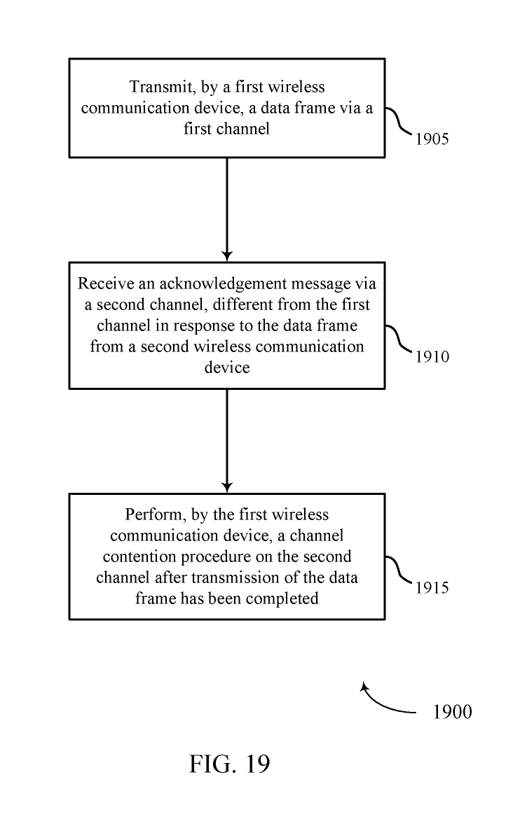

FIG. 19 shows a flowchart illustrating a method 1900 for using alternate channels for acknowledgement messaging in accordance with various aspects of the present disclosure. The operations of method 1900 may be implemented by a wireless communication device or its components as described with reference to FIGS. 1-11. For example, the operations of method 1900 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 1900 may also incorporate aspects of methods 1200, 1300, 1400, 1500, 1600, 1700, and 1800 of FIGS. 12-18.

At block 1905, the wireless communication device may transmit a data frame via a first channel as described with reference to FIGS. 2-6. In certain examples, the operations of block 1905 may be performed by the data transmission manager 910 as described with reference to FIG. 9.

At block 1910, the wireless communication device may receive an acknowledgement message via a second channel, different from the first channel in response to the data frame from a second wireless communication device as described with reference to FIGS. 2-6. In certain examples, the operations of block 1910 may be performed by the alternate channel manager 810 as described with reference to FIG. 8.

At block 1915, the wireless communication device may perform a channel contention procedure on the second channel after transmission of the data frame has been completed as described with reference to FIGS. 2-6. In certain examples, the operations of block 1915 may be performed by the channel contention manager 905 as described with reference to FIG. 9.

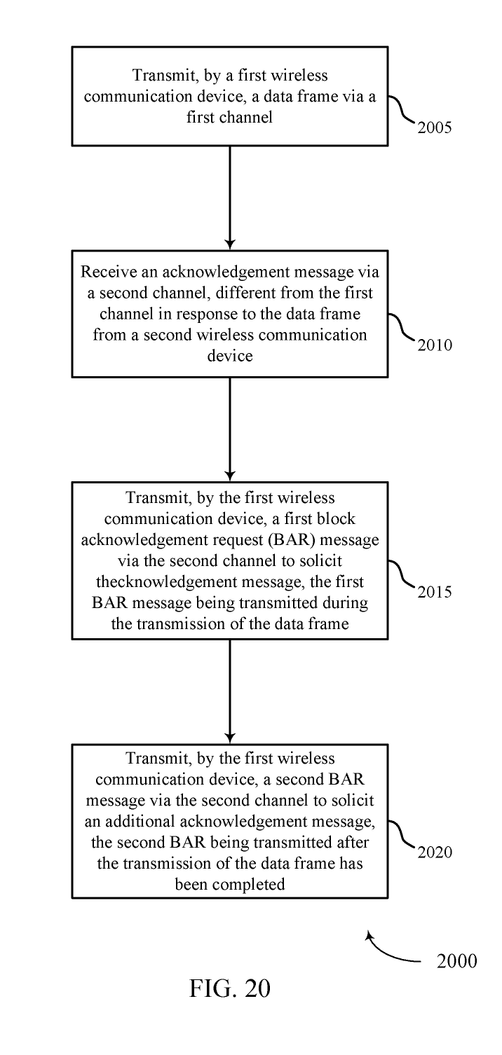

FIG. 20 shows a flowchart illustrating a method 2000 using alternate channels for acknowledgement messaging in accordance with various aspects of the present disclosure. The operations of method 2000 may be implemented by a wireless communication device or its components as described with reference to FIGS. 1-11. For example, the operations of method 2000 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 2000 may also incorporate aspects of methods 1200, 1300, 1400, 1500, 1600, 1700, 1800, and 1900 of FIGS. 12-19.

At block 2005, the wireless communication device may transmit a data frame via a first channel as described with reference to FIGS. 2-6. In certain examples, the operations of block 2005 may be performed by the data transmission manager 910 as described with reference to FIG. 9.

At block 2010, the wireless communication device may receive an acknowledgement message via a second channel, different from the first channel in response to the data frame from a second wireless communication device as described with reference to FIGS. 2-6. In certain examples, the operations of block 2010 may be performed by the alternate channel manager 810 as described with reference to FIG. 8.

At block 2015, the wireless communication device may transmit a first block acknowledgement request (BAR) message via the second channel to solicit the acknowledgement message, the first BAR message being transmitted during the transmission of the data frame as described with reference to FIGS. 2-6. In certain examples, the operations of block 2015 may be performed by the alternate channel manager 810 as described with reference to FIG. 8.

At block 2020, the wireless communication device may transmit a second BAR message via the second channel to solicit an additional acknowledgement message, the second BAR message being transmitted after the transmission of the data frame has been completed as described with reference to FIGS. 2-6. In certain examples, the operations of block 2020 may be performed by the alternate channel manager 810 as described with reference to FIG. 8.

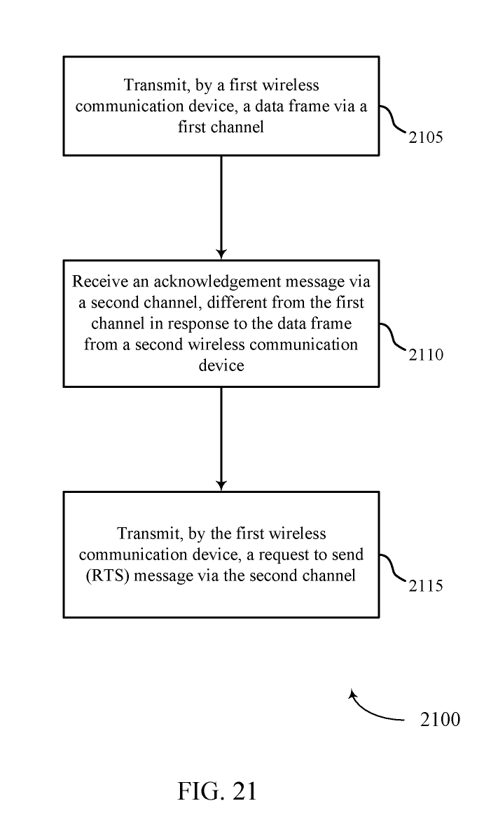

FIG. 21 shows a flowchart illustrating a method 2100 for using alternate channels for acknowledgement messaging in accordance with various aspects of the present disclosure. The operations of method 2100 may be implemented by a wireless communication device or its components as described with reference to FIGS. 1-11. For example, the operations of method 2100 may be performed by the alternate channel manager 710 as described with reference to FIGS. 7-10. In some examples, a wireless communication device may execute a set of codes to control the functional elements of the wireless communication device to perform the functions described below. Additionally or alternatively, the wireless communication device may perform aspects the functions described below using special-purpose hardware. The method 2100 may also incorporate aspects of methods 1200, 1300, 1400, 1500, 1600, 1700, 1800, 1900, and 2000 of FIGS. 12-20.

At block 2105, the wireless communication device may transmit a data frame via a first channel as described with reference to FIGS. 2-6. In certain examples, the operations of block 2105 may be performed by the data transmission manager 910 as described with reference to FIG. 9.

At block 2110, the wireless communication device may receive an acknowledgement message via a second channel, different from the first channel in response to the data frame from a second wireless communication device as described with reference to FIGS. 2-6. In certain examples, the operations of block 2110 may be performed by the alternate channel manager 810 as described with reference to FIG. 8.

At block 2115, the wireless communication device may transmit a request to send (RTS) message via the second channel as described with reference to FIGS. 2-6. In certain examples, the operations of block 2115 may be performed by the alternate channel manager 810 as described with reference to FIG. 8.

Thus, methods 1200, 1300, 1400, 1500, 1600, 1700, 1800, 1900, 2000, and 2100 may provide for using alternate channels for acknowledgement messaging. It should be noted that methods 1200, 1300, 1400, 1500, 1600, 1700, 1800, 1900, 2000, and 2100 describe possible implementation, and that the operations and the steps may be rearranged or otherwise modified such that other implementations are possible. In some examples, aspects from two or more of the methods 1200, 1300, 1400, 1500, 1600, 1700, 1800, 1900, 2000, and 2100 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
receiving at least a portion of a data frame from a first wireless communication device via a first channel; and
transmitting, by a second wireless communication device, a first acknowledgement message via a second channel, different from the first channel, in response to the received data frame.

2. The method of claim 1, wherein transmitting the first acknowledgement message via the second channel comprises:
transmitting the first acknowledgement message in response to the received data frame irrespective of a state of the second channel.

3. The method of claim 2, wherein the state of the second channel comprises a clear-channel assessment (CCA) state and/or a net allocation vector (NAV) state.

4. The method of claim 2, further comprising:
transmitting the first acknowledgement message within a short interframe space (SIFS) time after the data frame has been received.

5. The method of claim 1, further comprising:
performing, by the second wireless communication device, a channel contention procedure on the second channel after the data frame has been received; and
wherein transmitting the first acknowledgement message via the second channel comprises:
transmitting the first acknowledgement message when the second channel is determined to be available based at least in part on the channel contention procedure.

6. The method of claim 5, wherein performing the channel contention procedure on the second channel comprises:
performing a clear-channel assessment (CCA) of the second channel, and winning the second channel based at least in part on the performed CCA.

7. The method of claim 5, wherein performing the channel contention procedure on the second channel comprises:
determining a net allocation vector (NAV) state associated with the second channel is clear.

8. The method of claim 5, wherein performing the channel contention procedure on the second channel comprises:
performing the channel contention procedure utilizing enhanced distributed channel access (EDCA) techniques.

9. The method of claim 1, further comprising:
transmitting, by the second wireless communication device, a second acknowledgement message via the first channel in response to the received data frame.

10. The method of claim 9, wherein transmitting the second acknowledgement message comprises:
transmitting the second acknowledgement message via the first channel at a lower power level than a power level used to transmit the first acknowledgement message via the second channel.

11. The method of claim 1, further comprising:
decoding, by the second wireless communication device, a portion of the received data frame prior to an entirety of the data frame being received; and
wherein transmitting the first acknowledgement message via the second channel comprises:
transmitting a partial acknowledgement message associated with the decoded portion of the data frame.

12. The method of claim 11, further comprising:
transmitting, by the second wireless communication device, a subsequent acknowledgement message via the second channel when the entirety of the data frame has been received.

13. The method of claim 1, wherein the first channel operates in a wireless local area network (WLAN) frequency sub-band and the second channel operates in a non-wireless local area network (WLAN) frequency sub-band.

14. The method of claim 1, wherein transmitting the first acknowledgement message via the second channel comprises:
transmitting acknowledgement (ACK) message, or a block acknowledgment (BA) message, or a negative acknowledgment (NACK) message, or a combination thereof.

15. A method of wireless communication, comprising:
transmitting, by a first wireless communication device, a data frame via a first channel; and
receiving an acknowledgement message via a second channel, different from the first channel in response to the data frame from a second wireless communication device.

16. The method of claim 15, further comprising:
determining the first channel and the second channel are available for transmission; and
wherein transmitting the data frame via the second channel comprises:
transmitting the data frame when the first channel and the second channel are determined to be available.

17. The method of claim 16, wherein determining the first channel and the second channel are available for transmission comprises:
performing, by the first wireless communication device, a channel contention procedure on each of the first channel and the second channel.

18. The method of claim 15, further comprising:
transmitting, by the first wireless communication device, a request to send (RTS) message via the second channel.

19. The method of claim 18, wherein transmitting the data frame via the first channel comprises:
transmitting the data frame concurrently with the transmission of the RTS message or after the transmission of the RTS message.

20. An apparatus for wireless communication, comprising:
a data manager for receiving at least a portion of a data frame from a first wireless communication device via a first channel; and
an alternate channel manager for transmitting a first acknowledgement message via a second channel, different from the first channel, in response to the received data frame.
